(19) United States
(12) Patent Application Publication
(10) Pub. No.: US 2026/0233615 A1
(43) Pub. Date: Aug. 13, 2026

(54) Method and Device for Enabling a Vehicle Function

(71) Applicant: Bayerische Motoren Werke Aktiengesellschaft, Muenchen (DE)

(72) Inventor: Christopher DETMAR, Muenchen (DE)

(21) Appl. No.: 19/149,137

(22) PCT Filed: Nov. 23, 2023
(86) PCT No.: PCT/DE2023/100911

§ 371 Date: Jul. 18, 2025

(30) Foreign Application Priority Data
Jan. 20, 2023 (DE) 10 2023 101 447.1

(51) Int. Cl. B60L 3/00; B60L 3/04

(52) U.S. Cl. CPC B60L 3/0007; B60L 3/0046; B60L 3/04

(57) ABSTRACT

A device for enabling a function of a vehicle that is operated in a second electrical sub-network of an on-board electrical system of the vehicle, wherein the on-board electrical system of the vehicle includes a first sub-network having a first electrical stored energy source, where the device is designed to determine the status of the first sub-network, in particular the first stored energy source. The device is also designed to enable or disable the operation of the function within the second sub-network depending on the determined status of the first sub-network.

### BACKGROUND AND SUMMARY

The technology disclosed herein relates to a method and to a corresponding device which are designed to inhibit or enable the execution of a function of a vehicle in an efficient and secure manner.

A vehicle typically comprises a multiplicity of different safety-related functions, particularly safety-related components. A safety-related component, such as e.g. the valve of a pressure vessel, can be operated by a control device of the vehicle. Further to an accident, optionally, it can be desirable or necessary for the operation of one or more safety-related functions to be permanently inhibited.

A preferred object of the technology disclosed herein is the reduction or elimination of at least one disadvantage of a previously known solution, or the proposal of an alternative solution. A preferred object of the technology disclosed herein is the execution of a secure enablement or inhibition of a safety-related function of a vehicle.

This (these) object(s) are fulfilled by the subject matter disclosed herein. Preferred configurations are also represented in the present disclosure.

According to one aspect, a device (in particular, a control device) is described for enabling a function of a (motor) vehicle, wherein the function is operated in a second electrical sub-network of an on-board electrical system of the vehicle. The on-board electrical system of the vehicle further comprises a first sub-network having a first electrical energy store.

The on-board electrical system of the vehicle thus comprises a first sub-network and a second sub-network, which sub-networks typically assume different rated voltages. The first sub-network can comprise a first energy store, and the second sub-network can comprise a second energy store (in each case e.g. an electrochemical battery, for example a lithium-ion-Attorney based battery). The second electrical energy store can be designed to supply electrical energy for operating the function.

The first sub-network, in particular the first energy store, can assume a rated voltage in the high-voltage range, in particular 300 V or higher. The second sub-network, in particular the second energy store, can assume a rated voltage in the low-voltage range, in particular 60 V or lower (for example 48 V or 12 V). The on-board electrical system of the vehicle can further comprise a voltage converter, which is designed to transmit electrical energy from the first sub-network, in particular from the first energy store, to the second sub-network.

The vehicle can thus comprise an on-board electrical system which enables the operation of a function (e.g. of a specific vehicle component) within the second sub-network (using electrical energy from the second energy store), even in the event that the first sub-network, as a result of a malfunction (particularly as a result of an accident), has been decoupled from the on-board electrical system of the vehicle. To this end, the vehicle can comprise a fuse, in particular a pyro-fuse and/or a fusible link, which is tripped in the event of a malfunction (particularly in the event of an accident). Optionally, the fuse can be arranged within the housing of the first energy store. By the tripping of the fuse, in particular by the ignition thereof, an irreversible decoupling of the first sub-network, in particular of the first energy store, from the on-board electrical system can optionally be executed.

The vehicle function can be a safety-related function. In particular, it can be desirable or necessary that, further to a malfunction (particularly further to an accident), the function is not operated and/or is not operable. The function can comprise e.g. the valve of a pressure vessel for the storage of a fuel for operating an energy converter (e.g. for operating a fuel cell stack). Optionally, it can be intended to ensure that, further to a malfunction, particularly further to an accident, the valve cannot be opened, even if the valve is operated using electrical energy from the second sub-network.

The device is designed to ascertain the status of the first sub-network, in particular of the first energy store. In particular, this status can be ascertained with respect to a potential decoupling of the first sub-network, in particular of the first energy store, from the on-board electrical system. Decoupling of this type can be executed in response to a malfunction. The status of the first sub-network can thus be employed as an indicator of the occurrence of a malfunction, in particular of an accident.

The device can be designed to ascertain the status of the fuse, in particular of the pyro-fuse, of the first sub-network, in particular of the first energy store. The status of the first sub-network, in particular of the first energy store, can thus be ascertained, in an accurate manner, on the basis of the status of the fuse.

As mentioned above, the fuse can be configured, further to a malfunction of the vehicle, in particular further to an accident, to decouple the first sub-network, in particular the first energy store, from the on-board electrical system of the vehicle. The status of the first sub-network, in particular of the first energy store, can indicate whether the fuse has tripped, and particularly has been ignited, or otherwise.

The device can be designed to ascertain the value of the first network voltage of the first sub-network, in particular of the first energy store (e.g. by reference to a voltage measuring unit which is arranged on the first energy store). The status of the first sub-network, in particular of the first energy store, can thus be ascertained, in a particularly accurate manner, on the basis of the value of the first network voltage. In particular, by using the voltage value, it can be ascertained, in an accurate manner, whether the first sub-network, in particular the first energy store, has been decoupled from the on-board electrical system, or otherwise.

The device is further designed to enable or inhibit the operation of the function within the second sub-network, in accordance with the status of the first sub-network thus ascertained.

Optionally, operation of the function can be enabled and, in particular, can only be enabled, in the event that the status thus ascertained indicates that the first sub-network, in particular the first energy store, is coupled to the on-board electrical system of the vehicle. Alternatively or additionally, operation of the function can be enabled and, in particular, can only be enabled, in the event that the status thus ascertained indicates that the fuse for decoupling the first energy store from the on-board electrical system of the vehicle has not been tripped (and is thus still electrically conductive). Alternatively or additionally, operation of the function can be enabled and, in particular, can only be enabled in the event that the status thus ascertained indicates that the first sub-network, in particular the first energy store, assumes a first network voltage having a value which is equal to or greater than a voltage threshold value.

Conversely, operation of the function can be inhibited, in the event that the status thus ascertained indicates that the first sub-network, in particular the first energy store, has been decoupled from the on-board electrical system of the vehicle. Alternatively or additionally, operation of the function can be inhibited, in the event that the status thus ascertained indicates that the fuse for decoupling the first energy store from the on-board electrical system of the vehicle has been tripped. Alternatively or additionally, operation of the function can be inhibited, in the event that the status thus ascertained indicates that the first sub-network, in particular the first energy store, assumes a first network voltage having a value which is lower than the voltage threshold value.

A device is thus described which employs the status of the first sub-network, in particular of the first energy store, to execute a check as to whether a malfunction of the vehicle, in particular an accident, has occurred or otherwise. This status can be employed to initiate an efficient and secure enablement or inhibition of a safety-related function. Optionally, the status of the first sub-network can be checked repeatedly (e.g. in conjunction with each call-up of the function) and considered in the decision with respect to the enablement or inhibition of the function.

According to one example, the status of the fuse, in particular of the pyro-fuse, within the first energy store (in particular within the HV (high-voltage) store, for example having a rated voltage of 300 V or higher) can be ascertained. This status can be (securely) transmitted via a data communication network of the vehicle. Moreover, this status can be employed for enabling or inhibiting a function which is operated in the second sub-network.

According to a further aspect, a (road) motor vehicle (in particular a passenger car, or a heavy goods vehicle, or a bus, or a motorcycle) is described which comprises the device described in the present document.

According to a further aspect, a method is described for enabling a function of a vehicle, which function operates in a second electrical sub-network of an on-board electrical system of the vehicle, wherein the on-board electrical system of the vehicle comprises a first sub-network having a first electrical energy store. The method comprises the ascertainment of the status of the first sub-network, in particular of the first energy store. The method moreover comprises the enablement or inhibition of the operation of the function within the second sub-network, according to the status of the first sub-network thus ascertained.

According to a further aspect, a software (SW) program is described. The SW program can be designed for execution on a processor, in order to execute the method described in the present document. According to a further aspect, a storage medium is described. The storage medium can comprise a SW program which is designed for execution on a processor, in order to execute the method described in the present document.

It should be observed that the methods, devices and systems described in the present document can be employed both in isolation and in combination with other methods, devices and systems described in the present document. Moreover, any aspects of the methods, devices and systems described in the present document can be mutually combined in a variety of ways. In particular, the features of the claims can be mutually combined in a variety of ways. Moreover, features enclosed in brackets are to be understood as optional features.

The present disclosure is described in greater detail hereinafter with reference to exemplary embodiments.

### BRIEF DESCRIPTION OF DRAWINGS

FIG. 1 shows exemplary components of a vehicle; and

FIG. 2 shows a flow diagram of an exemplary method for enabling a function of a vehicle.

### DETAILED DESCRIPTION OF DRAWINGS

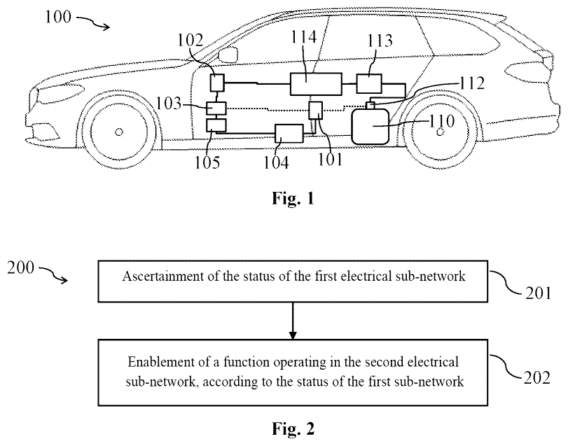

As described above, the present document addresses the secure and efficient enablement of a safety-related function. In this connection, FIG. 1 shows an exemplary vehicle 100 which comprises a pressure vessel system having a pressure vessel 110 and a valve 112. The pressure vessel 110 can be configured to store a fuel (e.g. hydrogen). The valve 112 can be opened, in order to convey fuel from the pressure vessel 110 to an energy converter 113, in particular to a fuel cell stack. The energy converter 113 can be designed, on the basis of the fuel, to generate electrical energy for operating an (unrepresented) drive motor of the vehicle 100. Electrical energy which is generated by the energy converter 113 can be stored in a first energy store 114 of the vehicle 100.

The first energy store 114 can be an element of a first electrical sub-system of the on-board electrical system of the vehicle 100. In the first electrical sub-network, one or more first electrical loads can be arranged, such as e.g. the drive motor of the vehicle 100, which loads are operated using electrical energy from the first energy store 114. The first sub-network can assume a first network voltage. The first network voltage can be a high voltage, e.g. having a voltage value of 300 V or higher, in particular of 600 V or higher.

The valve 112 can be actuated by a (control) device 101 of the vehicle 100, e.g. for the opening or closing of the valve 112 as required, for the adjustment of a degree of opening of the valve 112, and/or for ascertaining the status of the valve 112. The valve 112 is one example of a safety-related function, in particular of a safety-related component of the vehicle 100.

The valve 112 and/or the device 101 can be element(s) of a second electrical sub-network of the on-board electrical system of the vehicle 100. The second sub-network can assume a second network voltage, e.g. in a low-voltage range, for example a voltage of 60 V or lower. The second sub-network comprises a second electrical energy store 104.

The vehicle 100 can comprise a (DC) voltage converter 105, which is designed for transmitting electrical energy from the first sub-network to the second sub-network (and, optionally, in the inverse direction). A conversion from the first network voltage into the second network voltage can be executed.

The vehicle 100 can further comprise a fuse 102, which is configured to galvanically isolate the first sub-network, in particular the first energy store 114, from the on-board electrical system of the vehicle 100. The fuse 102 can comprise e.g. a pyro-fuse and/or a fusible link or a (semiconductor-based) switching element. The fuse 102 can be arranged between the first sub-network, in particular between the first energy store 114, and the voltage converter 105 which is routed to the second sub-network. In particular, the fuse 102 can be arranged in the housing of the first energy store 114.

For example, further to a safety-related malfunction, in particular further to an accident, it can be executed that the fuse 102 is tripped, in order to decouple the first sub-network, in particular the first energy store 114, from the on-board electrical system of the vehicle 100. A permanent and/or irreversible decoupling can be executed. As a consequence of the decoupling of the first sub-network, in particular of the first energy store 114, typically, the first sub-network is de-energized.

It can moreover be desirable and/or necessary that, further to a safety-related malfunction, in particular further to an accident, one or more safety-related functions of the vehicle 100 is/are (permanently and/or irreversibly) inhibited. This can be executed e.g. by a lock flag for the one or more safety-related functions in the (control) device 101.

In the present document, measures are described which enable a particularly efficient and secure (permanent and/or irreversible) inhibition of a safety-related function of a vehicle 100.

As described above, the valve 112 of the pressure vessel 110, by way of an example of a safety-related function, can be operated as an electrical load in the second sub-network. Decoupling of the first sub-network, in particular of the first energy store 114, typically has no direct effects upon the second sub-network. In particular, the second sub-network can continue to assume a second network voltage (which voltage is supported e.g. by the second energy store 104), even after the tripping of the fuse 102, such that a safety-related function which is operated within the second sub-network, such as e.g. the valve 112, continues to be supplied with electrical energy, and can thus be potentially operated, even further to the occurrence of a safety-related malfunction, in particular an accident.

The (control) device 101 can be designed, prior to the operation of a safety-related function which is operated using energy from the second sub-network, to check the status of the first sub-network, in particular of the first energy store 114. In particular, by reference to a (voltage) measuring unit 103, a check can be executed as to whether the first network voltage is still available, or otherwise. The measuring unit 103 can be arranged e.g. between the fuse 102 and the voltage converter 105.

By way of a status, it can thus be ascertained by the device 101 whether the first sub-network, in particular whether the first energy store 114, has been decoupled from the on-board electrical system, or otherwise. Operation of the safety-related function can thus be enabled or inhibited, according to the status thus ascertained. In particular, the operation of the safety-related function can be inhibited, in the event that the status indicates that the first sub-network, in particular the first energy store 114, (by the tripping of the fuse 102) has been decoupled from the on-board electrical system of the vehicle 100. Alternatively or additionally, operation of the safety-related function can be enabled (and, optionally, only enabled) in the event that the status indicates that the first sub-network, in particular the first energy store 114, is coupled to the on-board electrical system of the vehicle 100.

As described above, in the event that the vehicle 100 sustains an accident, the pyro-fuse 102 of the high-voltage store 114 can be ignited. The pyro-fuse 102 can be configured to interrupt the connection of the HV source of the store 114 to the exterior. The pyro-fuse 102 (and the fuse in general) can thus be arranged in the first energy store 114 (in particular in the housing of the first energy store 114). This tripping process is customarily completed before one or more further associated components of the vehicle 100 can potentially have sustained damage as a result of the accident. The ignition of a pyro-fuse 102 is irreversible such that, after ignition, it is necessary for the pyro-fuse 102 to be replaced.

In the event that an off-HV store function (i.e. a function which is operated in a second sub-network) is intended to ensure the irreversible inhibition after an accident, this function can be designed, to this end, such that the function polls the status of the HV store 114 in a cyclical or in a one-off manner. In the event that the HV store 114 does not deliver feedback which is indicative of full operational capability, it can be executed that the off-HV store function is not enabled.

FIG. 2 shows a flow diagram of an (optionally computer-implemented) method 200 for enabling an (optionally safety-related) function of a (motor) vehicle 100, which function is operated in the second electrical sub-network of the on-board electrical system of the vehicle 100, wherein the on-board electrical system of the vehicle 100 comprises a first sub-network having a first electrical energy store 114. The method 200 can be designed to ensure that the function is only operated in the event that no malfunction (in particular, no accident) of the vehicle 100 has previously occurred.

The method 200 comprises the ascertainment 201 of the status of the first sub-network, in particular of the first energy store 114. By way of a status, in particular, it can be ascertained whether the first energy store 114, as a result of the tripping of a fuse 102, has been decoupled from the on-board electrical system, or otherwise. This status can be employed as an indication as to whether a malfunction (in particular, an accident) of the vehicle 100 has occurred, or otherwise.

The method 200 further comprises the enablement or inhibition 202 of the operation of the function within the second sub-network, according to the status of the first sub-network thus ascertained, particularly according to whether or not the first energy store 114 has been decoupled from the on-board electrical system (as a result of the tripping of the fuse 102).

The status of the first sub-network, in particular of the first energy store, can thus be employed as an indicator of the presence of a malfunction. An efficient and secure enablement or inhibition of a safety-related function can thus be executed.

The present invention is not limited to the exemplary embodiments illustrated. In particular, it should be observed that the description and the figures are only provided by way of an exemplary illustration of the principle of the methods, devices and systems proposed.
LIST OF REFERENCE SYMBOLS
100 Vehicle
101 (Control) device
102 Fuse
103 Measuring unit
104 Second energy store
105 Voltage converter
110 Pressure vessel
112 Valve
113 Energy converter (fuel cell stack)
114 First energy store
200 Method for enabling or inhibiting a vehicle function
201-202 Process steps

1-10. (canceled)

11. A device for enabling a function of a vehicle, wherein the function is operated in a second electrical sub-network of an on-board electrical system of the vehicle including a first sub-network having a first electrical energy store, wherein the device is configured to:
ascertain a status of the first sub-network and/or the first energy store; and
enable or inhibit operation of the function within the second sub-network in accordance with the ascertained status of the first sub-network and/or the first energy store such that the operation of the function is inhibited in response to the status indicating that:
the first sub-network and/or the first energy store has been decoupled from the on-board electrical system of the vehicle; and/or
a fuse for decoupling the first energy store from the on-board electrical system of the vehicle has been tripped; and/or
the first sub-network and/or the first energy store assumes a first network voltage having a value that is lower than a voltage threshold value.

12. The device according to claim 11, wherein the device is configured to:
ascertain a status of the fuse of the first sub-network; and
ascertain the status of the first sub-network and/or the first energy store based on the status of the fuse.

13. The device according to claim 12, wherein the fuse is a pyro fuse of the first energy store.

14. The device according to claim 11,
wherein the vehicle comprises the fuse that is configured to, after an accident of the vehicle, decouple the first sub-network and/or the first energy store from the on-board electrical system of the vehicle, and
wherein the status of the first sub-network and/or the first energy store indicates whether the fuse has tripped.

15. The device according to claim 11, wherein the device is configured to:
ascertain a value of the first network voltage of the first sub-network and/or of the first energy store; and
ascertain the status of the first sub-network and/or the first energy store based on the value of the first network voltage.

16. The device according to claim 11, wherein the device is configured to:
enable the operation of the function in response to the ascertained status of the first sub-network and/or the first energy store indicating that the first sub-network and/or the first energy store is coupled to the on-board electrical system of the vehicle.

17. The device according to claim 11, wherein the device is configured to:
enable the operation of the function in response to the ascertained status of the first sub-network and/or the first energy store indicating that the fuse has not been tripped.

18. The device according to claim 11, wherein the device is configured to:
enable the operation of the function in response to the ascertained status of the first sub-network and/or the first energy store indicating that the first sub-network and/or the first energy store assumes a first network voltage having a value which is equal to or greater than the voltage threshold value.

19. The device according to claim 11,
wherein the on-board electrical system of the vehicle comprises a voltage converter configured to transmit electrical energy from the first sub-network and/or the first energy store to the second sub-network, and/or
wherein the second sub-network comprises a second electrical energy store configured to supply electrical energy for operating the function.

20. The device according to claim 11,
wherein the first sub-network and/or the first energy store assumes a rated voltage in a high-voltage range 300 V or higher; and/or
wherein the second sub-network and/or a second energy store of the second sub-network, assumes a rated voltage in a low-voltage range 60 V or lower.

21. A method for enabling a function of a vehicle, wherein the function is operated in a second electrical sub-network of an on-board electrical system of the vehicle, and wherein the on-board electrical system of the vehicle comprises a first sub-network having a first electrical energy store, the method comprising:
ascertaining a status of the first sub-network and/or the first energy store; and
enabling or inhibiting operation of the function within the second sub-network in accordance with the status of the first sub-network and/or the first electrical energy store, such that the operation of the function is inhibited in response to the status indicating that:
the first sub-network and/or the first energy store has been decoupled from the on-board electrical system of the vehicle; and/or
a fuse for decoupling the first energy store from the on-board electrical system of the vehicle has been tripped; and/or
the first sub-network and/or the first energy store assumes a first network voltage having a value that is lower than a voltage threshold value.

22. The method according to claim 21, comprising:
ascertaining a status of the fuse of the first sub-network; and
ascertaining the status of the first sub-network and/or the first energy store based on the status of the fuse.

23. The method according to claim 21,
wherein the vehicle comprises the fuse that is configured to, after an accident of the vehicle, decouple the first sub-network and/or the first energy store from the on-board electrical system of the vehicle, and
wherein the status of the first sub-network and/or the first energy store indicates whether the fuse has tripped.

24. The method according to claim 21, comprising:
ascertaining a value of the first network voltage of the first sub-network and/or of the first energy store; and
ascertaining the status of the first sub-network and/or the first energy store based on the value of the first network voltage.

25. The method according to claim 21, comprising:
enabling operation of the function in response to the ascertained status of the first sub-network and/or the first energy store indicating that the first sub-network and/or the first energy store is coupled to the on-board electrical system of the vehicle.

26. The method according to claim 21, comprising:
enabling operation of the function in response to the ascertained status of the first sub-network and/or the first energy store indicating that the fuse has not been tripped.

27. The method according to claim 21, comprising:
enabling operation of the function in response to the ascertained status of the first sub-network and/or the first energy store indicating that the first sub-network and/or the first energy store assumes a first network voltage having a value which is equal to or greater than the voltage threshold value.

28. The method according to claim 21,
wherein the on-board electrical system of the vehicle comprises a voltage converter configured to transmit electrical energy from the first sub-network and/or the first energy store to the second sub-network, and/or
wherein the second sub-network comprises a second electrical energy store configured to supply electrical energy for operating the function.

29. The method according to claim 21,
wherein the first sub-network and/or the first energy store assumes a rated voltage in a high-voltage range 300 V or higher; and/or
wherein the second sub-network and/or a second energy store of the second sub-network, assumes a rated voltage in a low-voltage range 60 V or lower.
